(19) United States
(12) Patent Application Publication
(10) Pub. No.: US 2018/0336589 A1
(43) Pub. Date: Nov. 22, 2018

(54) ADVERTISMENT TARGETING CRITERIA SUGGESTIONS

(71) Applicant: Facebook, Inc., Menlo Park, CA (US)

(72) Inventors: Xingyao Ye, Mountain View, CA (US); Okhee Kim, Mountain View, CA (US); Mark Teng Xia, San Jose, CA (US); Duy Ha, Redwood City, CA (US)

(21) Appl. No.: 15/599,192

(22) Filed: May 18, 2017

(51) Int. Cl. G06Q 30/02; H04L 29/08

(52) U.S. Cl. CPC G06Q 30/0251; H04L 67/22; G06Q 30/0276; G06Q 30/0201; G06Q 30/0204; G06Q 30/0277

(57) ABSTRACT

An online system suggests targeting criteria to advertisers creating new ads in the online system by generating a seed group of targeting criteria. The seed targeting criteria include targeting criteria already selected (if any), targeting criteria previously used, and targeting criteria extracted from the ad being created (e.g., from ad components) or a page being promoted by the ad. The seed targeting criteria are expanded via collaborative filtering on advertisers, collaborative filtering on targeted users, and determination of relationships within topic hierarchies. The online system selects a subset of the expanded targeting criteria by applying a machine learning model to each targeting criterion to determine a probability of the advertiser selecting the targeting criterion if it were suggested. The targeting criteria are ranked based on the determined probabilities and selected based on the ranking. The suggested targeting criteria may also be ordered in the user interface based on the ranking.

### BACKGROUND

This invention relates generally to online systems, and in particular to targeting criteria.

Many online systems collect revenue by showing third-party content to their users. Presenting third-party content to users allows the providers of the third-party content to obtain public attention for their products, services, opinions, or causes and can enable them to influence user actions. Large online systems provide a greater number of opportunities to expose users to third-party content, but it is often inefficient and expensive to present third-party content to all of the online system's users. In order to present their content more efficiently, third-party content providers may wish to only present their content to a subset of the general user population.

Users can be targeted based on attributes that they are associated with in the online system. That is, a third-party content provider can specify that the online system only present their content to users having one or more particular attributes. Large online systems may use a large number of attributes to describe their user with greater precision. However, third-party content providers may not be able to sort through all of the attributes used in the online system, which may be on the order of hundreds of thousands of separate attributes. Thus, it can be difficult for third-party content providers to accurately define the best audience for their content.

### SUMMARY

An online system suggests targeting criteria to advertisers that are creating new ads or ad campaigns in the online system. To do this, the online system generates a seed group of targeting criteria that includes target criteria the advertiser has already selected (if any), targeting criteria the advertiser has used in previous ads or ad campaigns, and targeting criteria extracted from the ad being created (e.g., from ad components) or a page being promoted by the ad. The seed group of targeting criteria is then expanded using techniques such as collaborative filtering on advertisers, collaborative filtering on targeted users, and determining relationships within topic hierarchies. The online system then selects a subset of the expanded targeting criteria as the suggested targeting criteria. This can be done by applying a machine learning model to each targeting criterion to determine a probability of the advertiser selecting the targeting criterion if it were suggested. The targeting criteria are then ranked based on the determined probabilities and selected based on the ranking. The suggested targeting criteria may also be ordered in the user interface based on the ranking.

### BRIEF DESCRIPTION OF THE DRAWINGS

FIG. 1 is a block diagram of a system environment in which an online system operates, according to one embodiment.

FIG. 2 is a block diagram of an online system, according to one embodiment.

FIG. 3 is a flow chart illustrating a method for suggesting targeting criteria, according to one embodiment.

FIG. 4 illustrates a user interface for suggesting targeting criteria, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to specific types of online systems 140, such as social networking systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

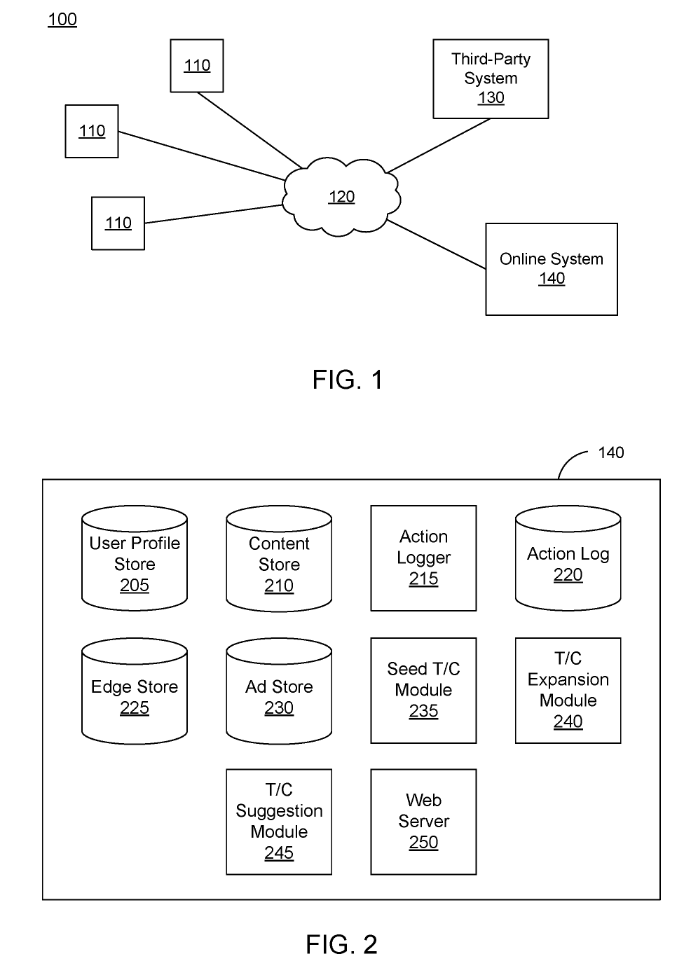

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device. In other embodiments, a third-party system 130 provides content or other information for presentation via a client device 110. A third-party system 130 may also communicate information to the online system 140, such as advertisements, content, or information about an application provided by the third-party system 130.

FIG. 2 is an example block diagram of an architecture of the online system 140. The online system 140 shown in FIG. 2 includes a user profile store 205, a content store 210, an action logger 215, an action log 220, an edge store 225, an ad store 230, a seed targeting criteria module 235, a targeting criteria expansion module 240, a targeting criteria suggestion module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

In some embodiments, a user profile associated with an advertiser (which may be either an individual user of the online system 140 or an entity like a third-party system 130) additionally stores historical ad data, which describes the advertiser's advertising history. Historical ad data can include information pertaining to past ad creation or performance. For example, when creating an ad or ad campaign, the advertiser specifies an audience by including or excluding targeting criteria. The information about ad creation may also include targeting criteria that were removed (e.g., initially selected but then removed before ad creation was completed) during the ad creation process. After the ad has been presented to users of the online system 140, performance information like impressions and conversions is gathered. Both types of information can be stored in conjunction with the corresponding ad or ad campaign, allowing the online system 140 to identify correlations between ad creation and performance.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third-party systems 130 that communicate information to the online system 140. Users may interact with various objects on the online system 140, and information describing these interactions are stored in the action log 220. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third-party system 130, such as an external website, and communicated to the online system 140. For example, an e-commerce website that primarily sells sporting equipment at bargain prices may recognize a user of a online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the social networking system, sharing a link with other users of the social networking system, and commenting on posts made by other users of the social networking system. Users and objects within the social networking system can represented as nodes in a social graph that are connected by edges stored in the edge store.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the online system 140 if the advertisement is presented to a user, if the advertisement receives a user interaction, or based on any other suitable condition. For example, the bid amount relates to a monetary amount that the online system 140 receives from the advertiser if the advertisement is displayed and the expected value is determined by multiplying the bid amount by a probability of the advertisement being accessed. In some cases, the amount paid to the social networking system is not the bid amount for an ad that has won an auction, but is the next highest bid amount of the next highest ranked advertisement in the auction.

Additionally, an advertisement request may include one or more targeting criteria specified by the advertiser. Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the online system 140. The targeting criteria may also specify interactions between a user and objects performed external to the online system 140, such as on a third-party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

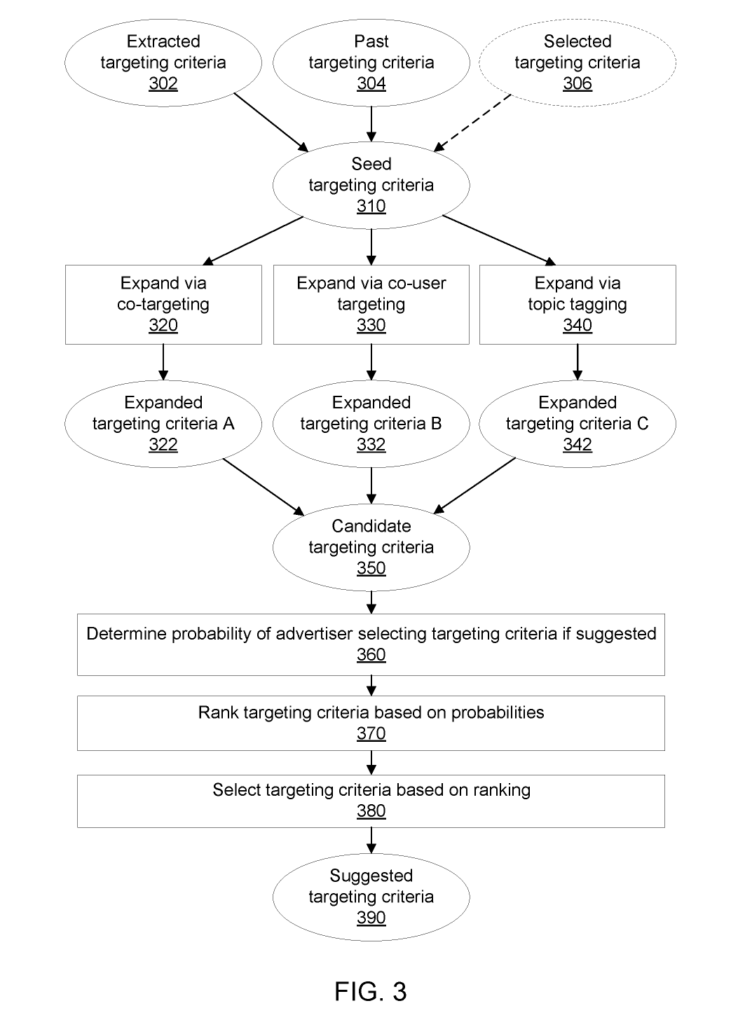

The seed targeting criteria module 235 identifies a small group of targeting criteria that can be used to “seed” various algorithms. Seed targeting criteria can be identified based on an advertiser that is specifying the audience, what ad the audience is being specified for, and targeting criteria that have already been used to define the audience. In many cases, the seed targeting criteria are used to represent at least a subset of the desired characteristics of the targeting criteria that will be generated based on the seed targeting criteria. Generating the seed targeting criteria is further discussed in conjunction with elements 302-310 of FIG. 3.

The targeting criteria expansion module 240 uses the seed targeting criteria from the seed targeting module 240 to generate a larger (“expanded”) group of targeting criteria. Various expansion algorithms can be applied to the seed targeting criteria to generate expanded targeting criteria. These expansion algorithms generate targeting criteria that are considered “similar” in some way to the seed targeting criteria and are further discussed in conjunction with steps 320-340 of FIG. 3.

The targeting suggestion module 245 determines and selects suggested targeting criteria based on one or more groups of expanded targeting criteria from the targeting criteria expansion module 245. To do this, the targeting suggestion module 245 determines probabilities for targeting criteria that reflect how likely the advertiser is to select the targeting criteria. The targeting suggestion module 245 may also rank and select targeting criteria if there are constraints on the number or probabilities of targeting criteria that can be suggested. Determining suggested targeting criteria is further discussed in conjunction with steps 360-380 of FIG. 3.

The web server 250 links the online system 140 via the network 120 to the one or more client devices 110, as well as to the one or more third-party systems 130. The web server 250 serves web pages, as well as other web-related content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, WEBOS® or RIM®.

### Method for Suggesting Targeting Criteria

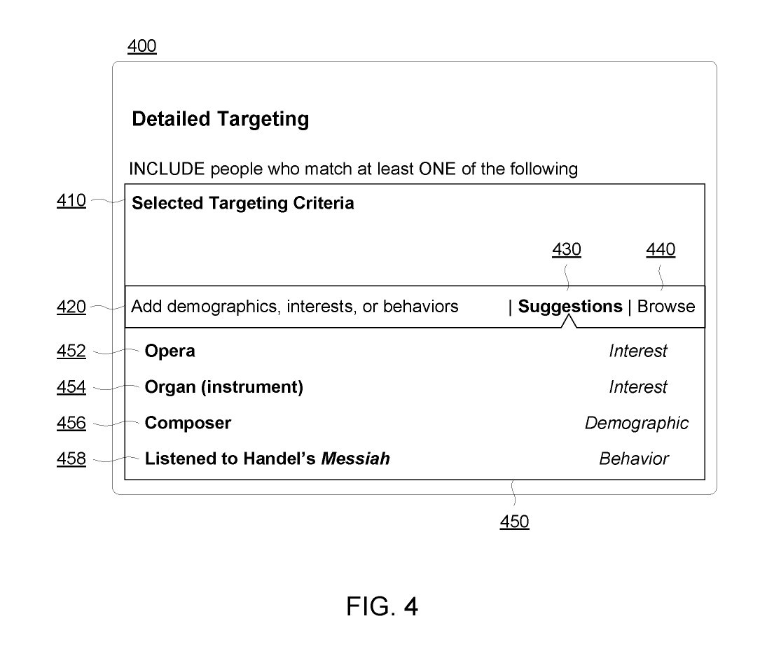

FIG. 3 is a flow chart illustrating a method 300 for generated suggested targeting criteria 390 for an ad, according to one embodiment. The online system 140 bases the seed targeting criteria 310 for its suggestion algorithm on a number of different sources. This variety of sources allows the online system 140 to generate suggested targeting criteria 390 even when one of the sources is not available for the advertiser (e.g., when the advertiser has not selected any targeting criteria), increasing the breadth of situations in which the online system 140 can provide effective suggested targeting criteria 390. Though FIGS. 3-4 are explained in terms of an ad that is being created, the methods described may also apply to ad campaigns in some embodiments.

The online system 140 can use multiple sources to generate seed targeting criteria 310. These sources may be based on the ad that is being created, or the advertiser creating the ad. Three primary sources described below that are used to create the seed targeting criteria 310 are extracted targeting criteria 302 from the ad, past targeting criteria 304 of the advertiser, and selected targeting criteria 306 for the ad. However, in other embodiments, the online system 140 may consider additional or different targeting criteria when generating the seed targeting criteria 310.

The online system 140 can extract targeting criteria from the ad being created, generating extracted targeting criteria 302. Specifically, the online system 140 extracts targeting criteria 302 from a page associated with the ad, such as a page that the advertiser is promoting via the ad. In particular, the page may be a landing page of a URL that is included in the ad. For example, the ad includes a link that directs the viewing user's browser to the landing page when selected (i.e., clicked on by the viewing user). The online system 140 retrieves the page (i.e., via the link), parses its content and, if applicable, identifies webpage metadata (e.g., title, tags, terms associated with images in the page, keywords). Targeting criteria can be then extracted from the page based on the parsed content (e.g., the description of the page, and images associated with the page), the webpage metadata, or topics related to the domain of the page. For example, “music” could be a term extracted from pages with “musicartist.com” as their domain. The online system 140 can additionally extract targeting criteria from the page by identifying targeting criteria associated with users of the online system 140 who are engaging with the page, and similar pages. In some embodiments, extracted targeting criteria 302 is extracted from pages of the online system 140. The online system 140 may additionally or alternately extract targeting criteria 302 from ad components provided by the advertiser, such as keywords from a description or text portion of the ad, and tags from images that have been uploaded.

The online system 140 can also identify targeting criteria 304 that the advertiser has previously used for its ads or ad campaigns. In one embodiment, all of the targeting criteria that the advertiser has previously used are included in the past targeting criteria 304. In another embodiment, only a subset of the targeting criteria that the advertiser has previously used is included in the past targeting criteria 304. For example, only targeting criteria from similar ads or ad campaigns may be included in the past targeting criteria 304. In one embodiment, ads or ad campaigns are considered “similar” if they have the same or overlapping ad components (or ad creatives, etc.). Other criteria or metrics for similarity may also be applied.

Additionally, in some embodiments, only those targeting criteria used by the other advertiser within a certain time period (e.g., within the last year, within the past six months, during a particular month, or since a specific date) are included in the past targeting criteria 304. A subset of the targeting criteria previously used by the advertiser may also be determined based on the number of times or frequency with which the advertiser used them within a time period. For example, the targeting criteria used more than a threshold number of times (e.g., ten) in the past six months may be included in the past targeting criteria 304. Similarly, if the advertiser uses particular targeting criteria in 90% (or another percentage above some threshold percentage) of the ads it creates, that targeting criteria may also be included in the past targeting criteria 304.

For ads where the advertiser has already selected some targeting criteria, the online system 140 can additionally include the selected targeting criteria 306 (or a subset thereof) in the seed targeting criteria 310. By selecting targeting criteria, the advertiser affirmatively indicates that the selected targeting criteria 306 are relevant to the ad that is being created, which makes those targeting criteria a good group of seed targeting criteria 310 for the expansion algorithms of the online system 140. However, as noted, the selected targeting criteria 306 are only a viable contributor to the seed targeting criteria 310 if the advertiser has already selected some targeting criteria. If the online system 140 were to solely relying on the selected targeting criteria 306 as the seed targeting criteria 310, then it would be unable provide the advertiser with any suggested targeting criteria 390 when the advertiser has yet to select any targeting criteria.

One or more of the sources discussed above are combined to form the seed targeting criteria 310. In some embodiments, each source makes up a predetermined number or proportion of the seed targeting criteria 310. For example, half of the seed targeting criteria 310 could be sourced from the selected targeting criteria 306 and a quarter of the seed targeting criteria 310 could be sourced from each of the past targeting criteria 304 and the extracted targeting criteria 302. Alternatively, a predetermined number or proportion (or up to a predetermined number or proportion) of each source may be included in the seed targeting criteria 310. For example, half of each of the extracted targeting criteria 302, the past targeting criteria 304, and the selected targeting criteria 306 could be included in the seed targeting criteria 310. In another embodiment, the seed targeting criteria 310 include all of the targeting criteria from the applicable sources.

After the group of seed targeting criteria 310 has been formed, the online system 140 uses one or more expansion methods to generate additional targeting criteria based on the seed targeting criteria 310. The targeting criteria generated via these expansion methods become the candidate targeting criteria 350 from which the suggested targeting criteria 390 are selected 380.

The online system 140 generates expanded targeting criteria 322 by applying a co-targeting 320 expansion method to the seed targeting criteria 310. Co-targeting 320 applies collaborative filtering to other advertisers that have used targeting criteria included in the seed targeting criteria 310. Specifically, the online system 140 identifies additional targeting criteria that other advertisers that have used one or more seed targeting criteria 310 also tend to use. For example, if Advertiser 1 has used Targeting Criteria A, B, and C, and Advertiser 2 has used Targeting Criteria A and C, the online system 140 could identify Targeting Criteria C via co-targeting 320 expansion as an additional targeting criterion for Advertiser 3 if the seed targeting criteria 310 of Advertiser 3 includes Targeting Criteria A. In some embodiments, co-targeting 320 expansion only considers targeting criteria that have been used by other advertisers within a certain timeframe. For example, only targeting criteria that have been used for ad creation by a particular advertiser within the past six months are used in the co-targeting 320 algorithm.

Additionally, the associations between other advertisers and targeting criteria they have used can be weighted. The weights can be based on how frequently the targeting criterion was used by the other advertiser, or the performance of targeting criterion (or the performance of the ad that included the targeting criterion. Targeting criteria associated with other advertisers may also be weighted based on how similar the other advertiser is to the advertiser in question. Similarity between advertisers can be determined based on the types of entity they are, the subject matter of ads they run, or the audiences they reach or engage. In some embodiments, similarity with the advertiser is also based on the number or proportion of seed targeting criteria 310 the other advertiser has used.

The online system 140 generates expanded targeting criteria 332 by applying a co-user targeting 330 expansion method to the seed targeting criteria. Co-user targeting 330 applies collaborative filtering to users that fit the seed targeting criteria 310. Specifically, the online system 140 identifies targeting criteria that users who already meet one or more seed targeting criteria 310 also tend to meet. For example, Users A, B, and C may all fulfill the targeting criteria “income: >$100,000” and “owns a house.” If the seed targeting criteria 310 includes “income: >$100,000,” expanded targeting criteria 332 may include “owns a house.” Similar to the co-targeting 320 expansion method, the filtering may be weighted based on how strong the user is associated with a particular targeting criterion, and how strongly the user is associated with the seed targeting criteria 310. For example, users who meet a larger number of the seed targeting criteria 310 may be weighted more heavily than other users who do not meet as many seed targeting criteria 310.

Topic tagging 340 is an expansion method that the online system 140 uses to generate expanded targeting criteria 342. Topic tagging 340 identifies targeting criteria based on their relationship to one or more seed targeting criteria 310 in a topic hierarchy. The topic hierarchy is organized (from most specific to broadest) based on keywords, semantic topics, and categories. Multiple targeting criteria that are associated with keywords are group under the umbrella of the appropriate semantic topic, and multiple semantic topics are grouped into categories. Targeting criteria are then recommended based on the keywords, semantic topics, and/or categories that the seed targeting criteria 310 fall into. Topic tagging 340 is further described in U.S. patent application Ser. No. 14/446,176, filed on Jul. 29, 2014, which is hereby incorporated by reference in its entirety. In one embodiment, topic tagging 340 can only be used with targeting criteria that are associated with a page of the online system. Examples of targeting criteria that are associated with pages of the online system include interests, educational institutions, professions, and workplaces.

For each of candidate targeting criteria 350, the online system 140 uses a machine learning model to determine 360 a probability of the advertiser selecting that targeting criterion if suggested. Features considered by the machine learning model can include selected targeting criteria 306, removed targeting criteria, past targeting criteria 304, previously selected targeting criteria (i.e., selected during creation of another ad by the same advertiser), and previously removed targeting criteria (i.e., removed during creation of another ad by the same advertiser). The machine learning model may additional consider performance-based features, such as how well targeting criteria used in previous ad campaigns by the advertiser performed, as measured by user impressions, clicks, conversion rate, and revenue.

After probabilities have been determined 360 for each of the candidate targeting criteria 350, the online system ranks 370 the candidate targeting criteria 350 using the determined 360 probabilities. For example, candidate targeting criteria 350 with higher probabilities are ranked before those that have lower probabilities.

The online system 140 selects 380 a subset of the targeting criteria as the suggested targeting criteria 390 based on the ranking 370. The online system 140 may select 380 a predetermined number of targeting criteria, or all targeting criteria with probabilities above a predetermined threshold probability. The suggested targeting criteria 390 may be subject to additional constraints, such as a minimum or maximum number of targeting criteria, or minimum or maximum probabilities.

The above embodiments have been explained with respect to targeting criteria that specify which users are to be included in an audience, however the above method can also apply to targeting criteria that specify which users are to be excluded from the audience. Additionally, the online system 140 may allow the third-party system 130 to specify Boolean combinations of targeting criteria and then provide the third-party system 103 with suggestions that include combinations of targeting criteria.

FIG. 4 illustrates a user interface 400 for suggesting targeting criteria, according to one embodiment. The user interface 400 allows advertisers to select one or more targeting criteria as part of the detailed targeting for the ad that they are creating. The user interface 400 includes a section 410 that displays any targeting criteria that the advertiser has selected. The user interface 400 also includes a search bar 420 that allows the advertiser to search for specific targeting criteria. The user interface 400 also includes an option to see targeting criteria suggestions 430 (i.e., suggested targeting criteria 390) or browse 440 all of the targeting criteria (e.g., by category and sub-categories). If an advertiser opts to look at the suggestions 430, a typeahead 450 with the suggested targeting criteria 390 is displayed. In some embodiments, the suggestions 430 are also presented when the advertiser is using the search bar 420. For example, the same suggestions 430 in the typeahead 430 would be displayed if the search bar 420 is empty, but if the search bar 420 includes some characters that have already been entered by the advertiser, only suggestions 430 including (or beginning with) those characters would be displayed.

In this example, there are no selected targeting criteria 390 displayed in section 410 because the advertiser has not yet selected any targeting criteria during this ad creation process. The suggestions 430 option has been selected, so the suggested targeting criteria 390 are displayed in the typeahead 450. The suggested targeting criteria 390 are ranked and include “opera” 452, “organ (instrument)” 454, “composer” 456, and “listen to Handel's Messiah” 458. The type of targeting criteria is also including alongside the suggested targeting criteria 390. That is, “opera” 453 and “organ (instrument)” 454 are interests, “composer” is a demographic, and “listened to Handel's Messiah” 458 is a behavior.

The suggested targeting criteria 390 are generated based on seed targeting criteria 310. For example, “Baroque music,” “singing,” and “musician” may be three past targeting criteria 304 were included in the seed targeting criteria 310. The expansion algorithms 320, 330, 340 then determined that “opera” 452, “organ (instrument)” 454, “composer” 456, and “listen to Handel's Messiah” 458 were similar targeting criteria. This could be for a number of reasons. For example, the expansion algorithms of the online system 140 may have included targeting criteria 452, 454 and 458 because they all relate to the Baroque music period. The expansion algorithms of the online system 140 may have further included targeting criteria 452 and 458 because they involve singing. Finally, the expansion algorithms 320, 330, 340 may have also determined that those targeting musicians” also commonly target “composers.”

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, from an advertiser, an advertisement for presentation to users of an online system;
extracting one or more terms from at least one of the advertisement and an account of the advertiser;
determining one or more seed targeting criteria for the advertisement, where the seed targeting criteria define whether a user is eligible to be presented with the advertisement based on whether one or more of the extracted terms matches information in a user profile of the user;
expanding the seed targeting criteria to obtain expanded targeting criteria, the expanded targeting criteria including a plurality of additional targeting criteria different from the seed targeting criteria, each of the additional targeting criteria derived from one or more of the seed targeting criteria;
selecting at least a subset of the expanded targeting criteria as suggested targeting criteria for the advertisement;
presenting the suggested targeting criteria to the advertiser;
receiving a selection of one or more of the suggested targeting criteria from the advertiser; and
using the selected targeting criteria to determine whether one or more users of the online system are eligible to be presented with the advertisement.

2. The method of claim 1, wherein the advertiser has not yet selected any targeting criteria for the advertisement.

3. The method of claim 1, wherein the seed targeting criteria comprises one or more past targeting criteria used for a prior advertisement of the account.

4. The method of claim 1, wherein the seed targeting criteria comprises one or more targeting criteria extracted from a page associated with the advertisement.

5. The method of claim 1, wherein the expanding comprises:
identifying additional targeting criteria that are associated with other accounts that specify one or more of the seed targeting criteria.

6. The method of claim 1, wherein the expanding comprises:
identifying additional targeting criteria that are associated with users who meet one or more of the seed targeting criteria.

7. The method of claim 1, wherein the expanding comprises:
identifying additional targeting criteria that are related to the seed targeting criteria in topic hierarchies.

8. The method of claim 1, further comprising:
determining, for each of the expanded targeting criteria, a probability of the targeting criterion being selected if presented to the advertiser,
wherein the selecting is based on the determined probabilities.

9. The method of claim 8, wherein the probabilities are determined by a machine learning model.

10. The method of claim 9, wherein the machine learning model is trained on data including performance information about targeting criteria previously used by the account.

11. A non-transitory computer-readable medium comprising instructions that when executed by a processor cause the processor to:
receive, from an advertiser, an advertisement for presentation to users of an online system;
extract one or more terms from at least one of the advertisement and an account of the advertiser;
determine one or more seed targeting criteria for the advertisement, where the seed targeting criteria define whether a user is eligible to be presented with the advertisement based on whether one or more of the extracted terms matches information in a user profile of the user;
expand the seed targeting criteria to obtain expanded targeting critiera, the expanded targeting criteria including a plurality of additional targeting criteria different from the seed targeting criteria, each of the additional targeting criteria derived from one or more of the seed targeting criteria, each of the additional targeting criteria derived from one or more of the seed targeting criteria;
select at least a subset of the expanded targeting criteria as suggested targeting criteria for the advertisement;
present the suggested targeting criteria to the advertiser;
receiving a selection of one or more of the suggested targeting criteria from the advertiser; and
using the selected targeting criteria to determine whether one or more users of the online system are eligible to be presented with the advertisement.

12. The non-transitory computer-readable medium of claim 11, wherein the advertiser has not yet selected any targeting criteria for the advertisement.

13. The non-transitory computer-readable medium of claim 11, wherein the seed targeting criteria comprises one or more past targeting criteria used for a prior advertisement of the account.

14. The non-transitory computer-readable medium of claim 11, wherein the seed targeting criteria comprises one or more targeting criteria extracted from a page associated with the advertisement.

15. The non-transitory computer-readable medium of claim 11, wherein the instructions that cause the processor to expand the seed targeting criteria comprise instructions to:
identify additional targeting criteria that are associated with other accounts that specify one or more of the seed targeting criteria.

16. The non-transitory computer-readable medium of claim 11, wherein the instructions that cause the processor to expand the seed targeting criteria comprise instructions to:
identify additional targeting criteria that are associated with users who meet one or more of the seed targeting criteria.

17. The non-transitory computer-readable medium of claim 11, wherein the instructions that cause the processor to expand the seed targeting criteria comprise instructions to:
identify additional targeting criteria that are related to the seed targeting criteria in topic hierarchies.

18. The non-transitory computer-readable medium of claim 11, wherein the instructions further cause the processor to:
determine, for each of the expanded targeting criteria, a probability of the targeting criterion being selected if presented to the advertiser,
wherein the selecting is based on the determined probabilities.

19. The non-transitory computer-readable medium of claim 18, wherein the probabilities are determined by a machine learning model.

20. The non-transitory computer-readable medium of claim 19, wherein the machine learning model is trained on data including performance information about targeting criteria previously used by the account.
